(19) United States
(12) Patent Application Publication
(10) Pub. No.: US 2010/0087176 A1
(43) Pub. Date: Apr. 8, 2010

(54) Method and Apparatus for Address Book Contact Management

(75) Inventor: Miraj Mostafa, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/562,850

(22) Filed: Sep. 18, 2009

Related U.S. Application Data
(60) Provisional application No. 61/098,197, filed on Sep. 18, 2008.

(51) Int. Cl. H04W 4/00

(52) U.S. Cl. 455/414.1

(57) ABSTRACT

A method comprises receiving an indication of contact information for a contact in an address book to be delivered to a recipient; retrieving the contact information for the contacts; and delivering the contact information to the recipient.

### RELATED APPLICATION

This application claims priority to U.S. Provisional Application No. 61/098,197 filed Sep. 18, 2008, which is incorporated herein by reference in its entirety.

### FIELD OF INVENTION

This invention relates to electronic address books. In particular, the present invention relates to updating of contacts in such address books.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Address books are referred to in the industry by various names, such as phonebook, contacts, etc. A Network Address Book (NAB) is an address book stored in a network. The Open Mobile Alliance (OMA) is in the process of standardizing an NAB in terms of a Converged Address Book (CAB).

With such standardization, CAB may define a network repository for the own contact information of a user, referred to as a Personal Contact Card (PCC). A user is expected to maintain and update his/her PCC in the network. The repository of the PCC's of various users is referred to herein as a PCC Server.

It is a common practice to send contact information to one or more recipients. The sending is variously referred to as a “send” operation, e.g. “provide”, “exchange”, “share”. In this regard, any contact information from an address book is sent to a device or a network repository of a user of interest. The contact information being sent may be part or full contact information of the sender or any contact entry of the address book owned by the sender. Further, the information sent may include contact information of any number of entries of the address book. Thus, in one case, the entire address book may be sent.

### SUMMARY OF THE INVENTION

In one aspect of the invention, a method comprises receiving an indication of contact information for a contact in an address book to be delivered to a recipient; retrieving the contact information for the contacts; and delivering the contact information to the recipient.

In one embodiment, the indication includes a pointer to the contact or the contact information. In one embodiment, the indication includes an address for the recipient. In one embodiment, the indication includes a pointer to an address for the recipient. In one embodiment, the receiving an indication is in response to a subscription to changes in contact information.

In one embodiment, the receiving an indication includes receiving a notification of an update to a document. The document may be an XML Document Management document.

In one embodiment, the indication includes an indication of an update to the contact information.

In one embodiment, the delivering the contact information includes use of a payload delivery system. The payload delivery system may be a messaging service. In another embodiment, the payload delivery system may be a transport protocol method or request.

In one embodiment, the delivering the contact information includes use of XDM-based delivery.

In one embodiment, the retrieving the contact information includes retrieving the contact information from a personal contact card server or a network repository of address book. In one embodiment, the method further comprises updating a network address book with updated contact information.

In another aspect, an apparatus comprises a processor and a memory unit communicatively connected to the processor. The memory unit includes computer code for receiving an indication of contact information for a contact in an address book to be delivered to a recipient; computer code for retrieving the contact information for the contacts; and computer code for delivering the contact information to the recipient.

In another aspect, the invention relates to a computer program product embodied on a computer-readable medium. The computer program product comprises computer code for receiving an indication of contact information for a contact in an address book to be delivered to a recipient; computer code for retrieving the contact information for the contacts; and computer code for delivering the contact information to the recipient.

These and other advantages and features of various embodiments of the present invention, together with the organization and manner of operation thereof, will become apparent from the following detailed description when taken in conjunction with the accompanying drawings.

### BRIEF DESCRIPTION OF THE DRAWINGS

Example embodiments of the invention are described by referring to the attached drawings, in which:

FIG. 1 is a schematic illustration of an exemplary architecture and flow of an address book management system according to an embodiment of the present invention;

FIG. 2 is a flowchart illustrating an exemplary contact information send process in accordance with embodiments of the present invention;

FIG. 3 is an overview diagram of a system within which various embodiments of the present invention may be implemented;

FIG. 4 illustrates a perspective view of an example electronic device which may be utilized in accordance with the various embodiments of the present invention; and

FIG. 5 is a schematic representation of the circuitry which may be included in the electronic device of FIG. 4.

### DETAILED DESCRIPTION OF THE VARIOUS EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

Currently, there is no standardized solution for sending contact information from a sender to a recipient, resulting in poor user experience. For example, different vendors and different implementations may use different transport mechanism (e.g., messaging services such as SMS, MMS) for sending contact information, and a user or device may not always be aware of the fact that contact information is hidden in a transport payload.

Further, sending contact information from a local copy in a device typically requires over-the-air transport of the whole contact information being sent. The mobile terminal may also need to process the information (e.g., encode/encrypt, decode/decrypt). This may exacerbate existing power management and corresponding delay issues.

In accordance with embodiments of the present invention, an extension of OMA XML Document Management (XDM) provides a solution for sending contact information. Thus, the solution can be standardized to have consistent user experience.

As used herein, a “contact” may refer to a person or an entity corresponding to contact information.

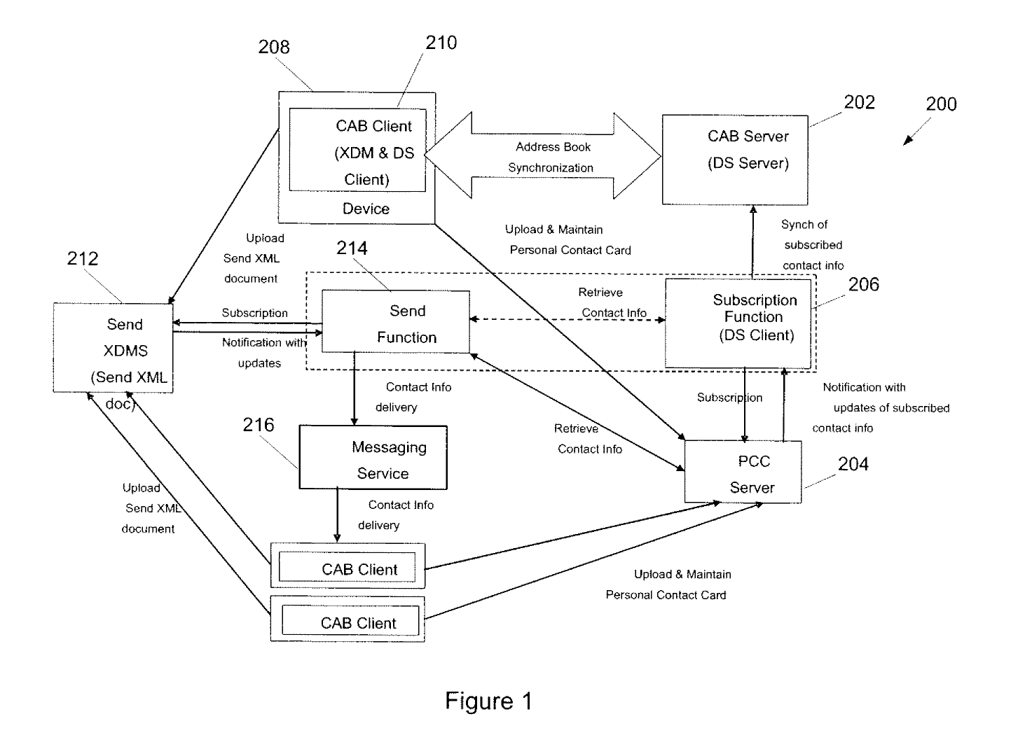

Embodiments of the present invention provide an efficient and reliable system, apparatus and method for sending contact information. Referring now to FIG. 1, an exemplary architecture and flow of an address book management system according to an embodiment of the present invention is schematically illustrated. The address book update system 200 includes a CAB server 202 configured to function as a server for the address book of a user. In one embodiment, as illustrated in parentheses in FIG. 1, the CAB server 202 includes the functionality of an OMA data synchronization (DS) server. A CAB client 210 is provided in a user device 208 to maintain both the address book of the user in the CAB server 202 and the personal contact card of the user in PCC Server 204. In the illustrated embodiment, the CAB client 210 also includes the functionality of a DS client. The CAB client 210 further includes XML Document Management (XDM) client functionality. As exemplarily illustrated in FIG. 1, the address book management system 200 may be configured to accommodate any number of CAB clients.

An interface may be provided between the CAB client 210 and the CAB server 202. This interface may be configured to support the data synchronization between the CAB client 210 and the CAB server 202 and may support the following functions:
1) data synchronization protocol of the CAB;
2) CAB management function such as add, delete, update of the CAB; and
3) mutual authentication with the CAB client 210.

A Personal Contact Card (PCC) server 204 is provided to function as a repository of the PCC's of various users.

In accordance with embodiments of the present invention, a subscription function (SF) 206 is provided between the CAB server 202 and the PCC server 204. The SF 206 may be a stand-alone network entity, or may be included within any other network entity. In the illustrated embodiment, the SF 206 is configured to function as a DS client. In accordance with embodiments of the present invention, the DS client and the SF may belong to the same logical entity. Thus, the DS client may be coupled with the SF. In accordance with embodiments of the present invention, synchronization of the address book is performed between the CAB client 210 and the CAB server 202.

The CAB client 210 is configured to manage an XML Document Management (XDM) document, referred to herein as a “Send XML document”, in a Send XDM Server (XDMS) 212 by XDM operations. In the illustrated embodiment of FIG. 1, a Send XDMS 212 is used to store the Send XML document. In various embodiments, any XDMS may be used for this purpose. As part of managing the Send XML document, the CAB client is configured to update the Send XML document with the contact information that is to be sent, as well as with the recipient address. In various embodiments, the contact information may include part or full information about one or more contact entries in an address book of the sending user and/or part or the full information of Personal Contact Card of the sending user. In some embodiments, the contact information and/or the recipient information may include a pointer to the contact information and/or the recipient address.

Thus, in one example, if the sending user wants to send only the phone number of “Contact A” to the phone number of “Contact B”, the update may include the identification of the contact entry of “Contact A” (e.g., SIP URI or e-mail address of “Contact A”) and the parameter corresponding to the phone number in the contact card format (e.g., TEL type in the vCard format) to point to the contact information; and the identification of the contact entry of “Contact B” (e.g., SIP URI or e-mail address of “Contact B”) and the parameter corresponding to phone number in the contact card format (e.g., TEL type in the vCard format) to point to the recipient address. Alternatively, the phone number of both “Contact A” and “Contact B” can be included.

In accordance with embodiments of the present invention, a network entity, Send Function 214, is configured to subscribe for changes in the Send XML document in the Send XDMS 212 of the users and, thus, gets a notification with each update made in the Send XML document. The Send Function 214 is further configured to retrieve the contact information from the Subscription Function 206, if pointer to contact information is included in the Send XML document. The Send Function 214 may be a stand-alone network entity, or it may be part of any other network entity, such as, for example, the Subscription Function 206.

In one embodiment, a messaging service 216 is configured to provide delivery of the contact information to the recipient address, which may be other CAB clients. Example messaging services that can be used are SMS, MMS, IM, E-mail. In other embodiments, any other transport or service may be used for delivery of the contact information to the recipient provided that the transport/service provides the necessary means for delivery. For example, protocols such as SIP, HTTP can be used in this regard with some definition of payload and the values of some headers. When the SIP protocol is used, the MESSAGE method may be used.

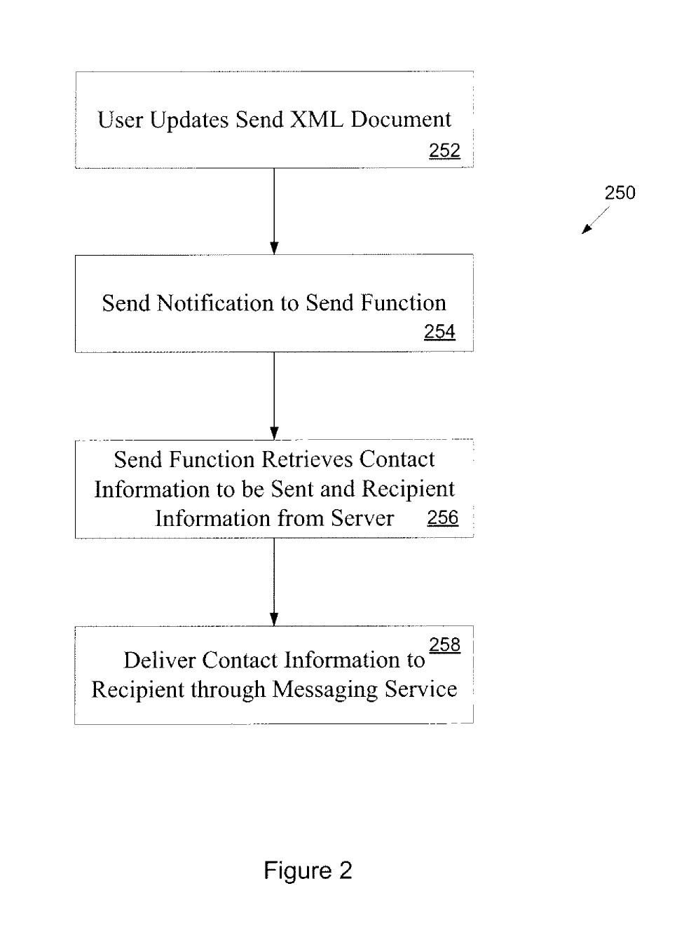

Referring now to FIG. 2, a process 250 for sending contact information in accordance with embodiments of the present invention is illustrated. In accordance with embodiments of the present invention, when a user wants to send contact information, an XDM document (the Send XML document) in a Send XDM Server (XDMS) in the network is updated with the contact information or a pointer to the contact information to be sent (block 252). The update may also include the recipient address or pointer to the recipient address where the contact information is to be sent.

A network entity, such as the Send Function 214 illustrated in FIG. 1, may subscribe for any change in the Send XML document of the user. Thus, when the user makes any update in the document, the Send Function gets a notification with the update (block 254). Upon receiving the update, the Send Function retrieves the contact information and/or the recipient address from the associated server if the update include a pointer to contact information and/or recipient address, respectively (block 256). In one embodiment, the Send Function uses an XDM approach (e.g., XML Configuration Access Protocol (XCAP) operation) for retrieval of the information. If the update includes the contact information and recipient address, the retrieval operation may not be required. The address book server or any proxy/server can act as the Send Function instead, in various embodiments.

Upon retrieving the contact information (that the user decided to send) and recipient address (where the user wants to send the contact information), the Send Function can use a suitable messaging service or a transport mechanism for the delivery of the contact information to the recipient address (block 258).

In one embodiment, a conventional messaging service, such as SMS, MMS, e-mail, or IM, may be used to deliver the contact information. As almost all mobile terminal support SMS, SMS may be used if the contact information does not exceed the limit of allowed SMS payload. In some embodiments, concatenated SMS may be used if multiple SMS messages are required to deliver the desired contact information. If the contact information includes an icon or an image and/or the contact information of many contacts, many SMS messages are required to send the desired contact information; As an alternative, MMS or e-mail may be used in instances where many SMS messages are required.

Contact information of multiple contacts may be easily encoded within multipart/mixed or multipart/related MIME objects. An image or an icon may also be embedded or referred from a MIME multipart/related object. Both MMS and E-mail support MIME encoding. E-mail would be a useful transport, when contact information is sent to an e-mail address, though MMS may be also used to sent information to an e-mail address. Instant Messaging (IM) may also be used, particularly if the recipient address is an IM address (e.g. SIP URL).

In accordance with embodiments of the present invention, upon receiving a message (e.g., SMS, MMS, e-mail, IM), the recipient terminal decodes the message and automatically looks at the content of the message. If the recipient terminal finds that the content of the message is contact information, it informs the recipient user that contact information has been received and asks the recipient user for permission to save the contact information in her address book. In some embodiments, the recipient device can store the contact information directly to the address book if the recipient terminal has been accordingly configured by the user or service provider.

Upon storing the contact information in the local copy of the address book of the recipient terminal, the recipient terminal may start synchronization of the address book with the network-based master copy of the address book, if there is a such network-based address book. Upon the update in the network-based address book with the received contact information, the local copy of the address book in other possible devices owned by the same recipient user would be eventually updated by follow-up synchronization process.

In some embodiments, XDM can also be extended to deliver the desired contact information to the recipient address. In this case, the Send Function or a suitable entity first resolves the recipient address, and finds if it belongs to the local domain or a remote domain. If the recipient belongs to a local domain, the Send Function updates the network-based address book of the recipient user by synchronization. Before synchronization, the Send Function may ask for permission from the recipient user to perform such an update, or the Send Function may act based on the configuration set by the user or the service provider. On the other hand, if the recipient user belongs to a remote domain, the Network-Network Interface (NNI) of XDM may be extended to carry the desired contact information to a corresponding Send Function (or other such entity) of the remote domain. Thereafter, the Send Function of the remote domain may update the network-based address book of the recipient user in the remote domain as described above. In some embodiments, an XDM-based delivery of contact information may be complex and demanding since XDM has to perform address resolution, routing, user interaction, and synchronization. If a messaging service is used instead, as described above, XDM can rely on the messaging service for address resolution, routing user interaction and synchronization, as the messaging service may support all these functions.

In some embodiments, with reference to FIG. 1, the Send Function 214 and the Subscription Function 206 may be combined since both need to support both subscription/notification and other XDM operations. In this case, retrieval of contact information by the Send function 214 from the Subscription Function 206 may not be required. In other embodiments, the Send Function 214 may be combined with the CAB Server 202, the PCC Server 204 or any other server/proxy. Similarly, in some embodiments, the Send XML document may reside in any XDMS, such as the Send XDMS 212 of FIG. 1.

In accordance with various embodiments of the present invention, as noted above, the recipient terminal may be configured to decode a received message and determine if the content of the message includes contact information. In some embodiments, if the message is MIME encoded, the value of the MIME Content-Type header can directly indicate if the content is contact information. For example, if the value is text/x-vCard or application/directory, it implies that the content is contact information. In some embodiments, the header may have some generic value (e.g., text/plain), or the message may not be MIME encoded (e.g., in case of SMS). In these cases, the recipient terminal may still understand from the specifics of the content if contact information is included in the message. For example, the vCard format always begins and ends with BEGIN and END type with VCARD as the value.

Thus, embodiments of the present invention provide an efficient and consistent manner of sending contact information for one or more contacts in an address book.

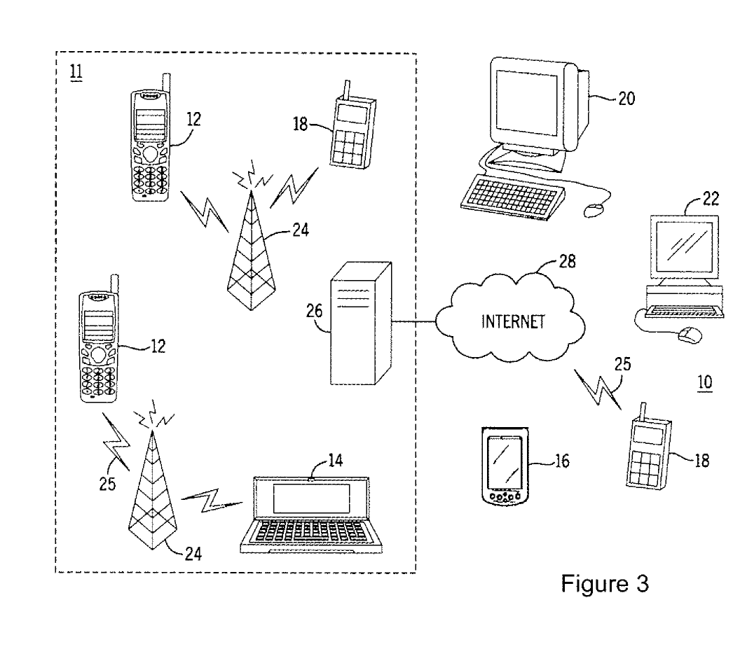

FIG. 3 shows a system 10 in which various embodiments of the present invention can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 3 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The example communication devices of the system 10 may include, but are not limited to, an electronic device 12 in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

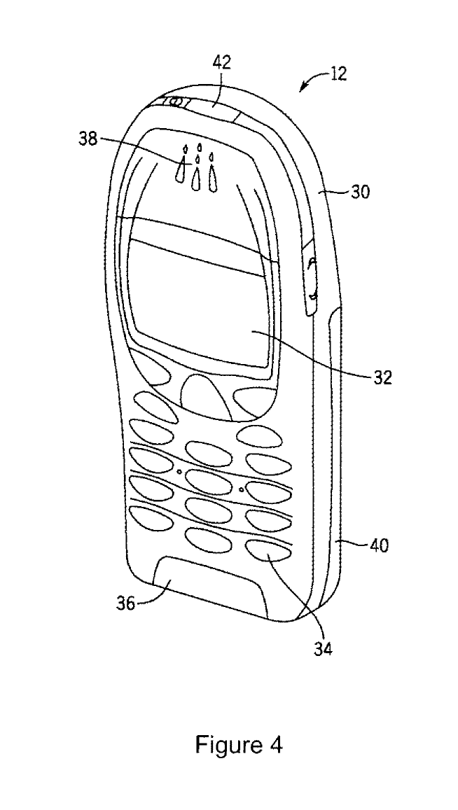

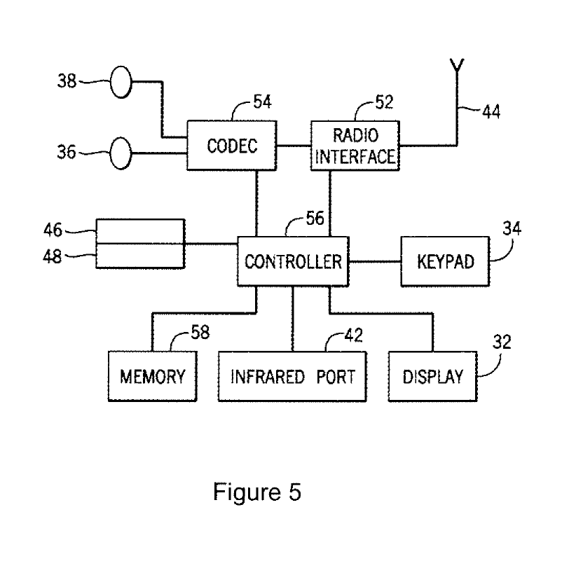

FIGS. 4 and 5 show one representative electronic device 28 which may be used as a network node in accordance to the various embodiments of the present invention. It should be understood, however, that the scope of the present invention is not intended to be limited to one particular type of device. The electronic device 28 of FIGS. 4 and 5 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. The above described components enable the electronic device 28 to send/receive various messages to/from other devices that may reside on a network in accordance with the various embodiments of the present invention. Individual circuits and elements are all of a type well known in the art, for example in the Nokia range of mobile telephones.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments of the present invention may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method, comprising:
receiving an indication of contact information for a contact in an address book to be delivered to a recipient;
retrieving the contact information for the contacts; and
delivering the contact information to the recipient.

2. An apparatus, comprising:
a processor; and
a memory unit communicatively connected to the processor and comprising:
computer code for receiving an indication of contact information for a contact in an address book to be delivered to a recipient;
computer code for retrieving the contact information for the contacts; and
computer code for delivering the contact information to the recipient.

3. The apparatus of claim 2, wherein the indication includes a pointer to the contact or the contact information.

4. The apparatus of claim 2, wherein the indication includes an address for the recipient.

5. The apparatus of claim 2, wherein the indication includes a pointer to an address for the recipient.

6. The apparatus of claim 2, wherein the computer code for receiving an indication is responsive to a subscription to changes in contact information.

7. The apparatus of claim 2, wherein the computer code for receiving an indication includes computer code for receiving a notification of an update to a document.

8. The apparatus of claim 7, wherein the document is an XML Document Management document.

9. The apparatus of claim 2, wherein the indication includes an indication of an update of the contact information.

10. The apparatus of claim 2, wherein the computer code for delivering the contact information includes use of a payload delivery system.

11. The apparatus of claim 10, wherein the payload delivery system is a messaging service.

12. The apparatus of claim 10, wherein the payload delivery system is a transport protocol method or request.

13. The apparatus of claim 2, wherein computer code for delivering the contact information includes use of XDM-based delivery.

14. The apparatus of claim 2, wherein the computer code for retrieving the contact information includes computer code for retrieving the contact information from a personal contact card server or a network repository of address book.

15. The apparatus of claim 2, wherein the memory unit further includes:
computer code for updating a network address book with updated contact information.

16. A computer program product, embodied on a computer-readable medium, comprising:
computer code for receiving an indication of contact information for a contact in an address book to be delivered to a recipient;
computer code for retrieving the contact information for the contacts; and
computer code for delivering the contact information to the recipient.
